(19) United States
(12) Patent Application Publication
(10) Pub. No.: US 2004/0098287 A1
(43) Pub. Date: May 20, 2004

(54) System and method for rating services on an internet site

(75) Inventors: Anthony Barrett Young, Springfield, MO (US); Christopher Lynch, Springfield, MO (US); Tracy Lynn Frey, Springfield, MO (US)

Correspondence Address: SCOTT B. STROHM, SHOOK, HARDY & BACON L.L.P., 1200 Main Street, Kansas City, MO, 64105-2118, US

(73) Assignee: TRAVELNOW.COM INC.

(21) Appl. No.: 10/295,707

(22) Filed: Nov. 15, 2002

(51) Int. Cl. G06F 17/60

(52) U.S. Cl. 705/5; 705/1

(57) ABSTRACT

An apparatus and method for execution in a computer system are provided. The apparatus and method are used to collect data relevant to an information provider, such as an Internet travel agency, about a service provider, such as a hotel. This data is primarily related to the payment performance of the service providers to the agency. The collected information is used to determine an order or ranking of the service providers. The determination includes performing a number of different calculations with the collected data to produce a number of important variables. The variables are then weighted and summed to arrive at a rating value for each hotel. The rating value determines the order in which the service providers are displayed to a computer user. In use, the method provides an incentive to the service providers to improve their payment performance, so that they will be presented at or near the top of the list of service providers that is presented to the computer user.

### TECHNICAL FIELD

In general, the present invention relates to a method and system for use on a computer, and more particularly, to a method and system for assigning a confidence rating to service providers, such as hotels, that are offered through an internet site, so that a meaningful rating is applied to the service providers based upon certain attributes, such as their payment performance to the internet agency or affiliate.

### BACKGROUND OF THE INVENTION

The manner in which consumers book hotel and other travel services has changed over the last several years. In the hotel reservation system, for example a consumer may use a traditional travel agent, or may use an Internet service to directly view the available hotels and prices. The Internet service may also be used to book the hotel room.

In the Internet service model, the Internet travel site uses a global distribution system, or GDS. The GDS is a computerized reservation network that aggregates data regarding travel offerings. The data is presented by the Internet travel site to computer users which allows the users to individually book a hotel room at the displayed price. The GDS therefore provides the needed databases and connectivity to the hotels and other service providers, and directly interfaces with the service provider's reservation system. In a sense, the GDS serves as a middleman between a travel agent and the hotel or other service provider. The GDS is typically compensated by the Internet agencies and the service providers. This compensation is independent of any transactions between the service providers and the Internet agencies.

On a separate level, the Internet agencies and the service providers also have a relationship that is similar to that between the service providers and the traditional travel agent. In these relationships, the service provider typically pays a commission to the travel agency for any travel services booked by the travel agent. Usually this commission is on a percentage basis, such as ten percent or the reservation value. A number of factors are of interest to the Internet agency regarding the payment by a service provider to the Internet agency. For example, the Internet agency is interested in the timeliness of a service provider's payment of the commission. Additionally, the commission percentage paid is of interest, as are any reported non-commissionable bookings. An example of a non-commissionable booking includes bookings made by military personnel, who typically receive a discount. Another example of a non-commissionable booking is where the service provider arbitrarily determines that a commission should not be paid, such as if it were offering a special discounted rate where the service provider had determined that it would not pay commissions to the internet agency.

The Internet agency usually lacks data on the factors of interest to the Internet agency regarding the travel services. For example, Internet agencies typically do not track the timeliness of a service provider's commission payments, the percentage amount of the commission paid, and the number of reported non-commissionable bookings. Even when an Internet agency is armed with data regarding a service provider's commission payments, the agency may lack the leverage needed to encourage a service provider to improve its payment history. This lack of leverage stems, in part, from the structure of the agency relationships discussed above. For example, the service provider's status with the GDS is not affected by any payment performance between the service provider and the Internet agency. So long as the hotel is in good standing with the GDS, the GDS continues to list the service provider. The GDS typically returns a random ordered list of service providers matching a search query that is in no way dependent upon a service provider's payment to an internet agency. It would therefore be desirable to Internet agencies to provide incentives to service providers to make timely commission payments at the full commission percentage and to reduce their reporting of non-commissionable bookings.

As discussed above, Internet travel agencies are now becoming more common and are widely used by individuals. These Internet agencies allow individuals to search for available hotel rooms and other services by city for a particular date. Once a search is performed, results are returned to the computer user listing the service providers and their availability that matches the search criteria. The order in which these results are returned is very important to the service providers. The results are typically returned in groups, called pages. A page may contain, for example, the first ten service providers meeting the search criteria. The computer user then has the opportunity to page through the results to view all the available service providers. However, it has been found that a typical computer user does not page through all the results but instead is more apt to select a service provider from among those first-listed. Therefore, it would be desirable to Internet agencies to be able to list the service providers in a manner which benefited the Internet agencies' interests.

In the past, available service providers were listed in a number of different ways. For example, the service providers may be displayed by the Internet agency in an ordered list from the lowest available price to the highest. As stated above, however, the GDS returns the results to the Internet agency in a random list that is not ordered in any particular way. As another example, the service providers may be displayed by the Internet agency in alphabetical order. Finally, in some instances, the list may even be influenced by various contractual arrangements between the service providers and the Internet agencies. These contractual arrangements can move certain branded service providers to the top of the list displayed. It would be desirable to provide a method for ordering the returned list based upon the payment performance of the service provider.

This ordering would also be beneficial to affiliates of the Internet agencies. Internet agencies typically have relationships with a number of affiliates that use the services of the Internet agency. These affiliates appear to the user as the entity that is providing the search services, when in reality it is the Internet agency. In this relationship, any commissions paid by the service provider are to the Internet agency. After receiving payment from the service provider, the Internet agency pays a commission to the affiliate. Therefore, the affiliates are also interested in determining whether a service provider pays in a timely fashion and the size of the commissions paid, because the timeliness and size of the compensation paid to the affiliate depends upon the payment of the service provider to the internet agency. It is therefore in the interest of the affiliate to promote those service providers that have a good payment performance record.

### BRIEF SUMMARY OF THE INVENTION

The present invention is directed to an apparatus and method for execution in a computer system. The apparatus and method are used to collect data relevant to an information provider, such as an Internet travel agency, about a service provider, such as a hotel. This data is primarily related to the payment performance of service providers to the agency. The collected information is then used to determine an order or ranking of the service providers. The determination includes performing a number of different calculations with the collected data to produce a number of important variables. The variables are then weighted and summed to arrive at a rating value for each service provider. The rating determines the order in which the service providers are displayed to a computer user. In use, the method provides an incentive to the service providers to improve their payment performance, so that they will be presented at or near the top of the list of service providers that is presented to the computer user.

Additional advantages and novel features of the invention will be set forth in the description which follows, and in part will become apparent to those skilled in the art upon examination of the following, or may be learned from practice of the invention.

### BRIEF DESCRIPTION OF THE SEVERAL VIEWS OF THE DRAWINGS

The present invention is described in detail below with reference to the attached drawing figures, wherein:

FIG. 1 is a block diagram of a computing system environment suitable for use in implementing the present invention; and

FIG. 2 is a flow chart illustrating certain aspects of the present invention.

### DETAILED DESCRIPTION OF THE INVENTION

The present invention provides a method and computer system for use in the area of Internet travel agencies. The method and system are used to collect and track data regarding a service provider, and specifically their payment data to the on-line travel agency. Using the collected data, a weighting analysis is performed that results in a rating assigned to each service provider. If a service provider does not have a rating meeting a certain threshold value, the service provider may not be presented to users of the on-line travel agency as an option. For each of the service providers meeting the threshold, the rating value is used to order the results that are returned to the computer user as an option for booking. In this way, the service providers are given an incentive to improve their payment performance. Much of the discussion below relates to the application of the invention using a hotel as a service provider. It should be understood, however, that the use of a hotel as a service provider is merely exemplary of one application of the invention, and that other service providers, such as car rental agencies or airlines are contemplated by the invention.

Having briefly described an embodiment of the present invention, an exemplary operating environment for the present invention is described below.

Exemplary Operating Environment

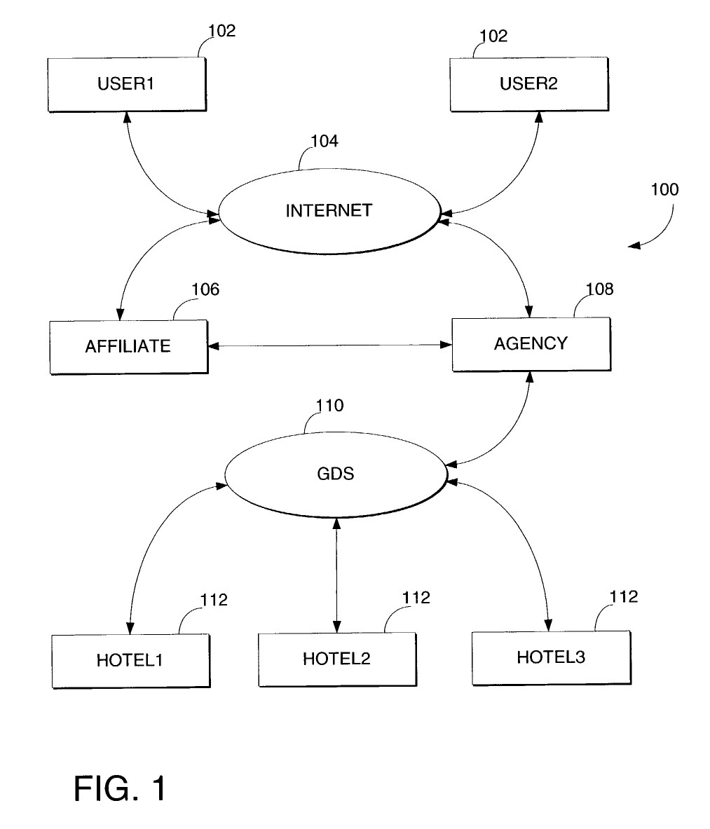

FIG. 1 illustrates an example of a suitable computing system environment 100 in which the invention may be implemented. The computing system environment 100 illustrated is only one example of a suitable computing environment and is not intended to suggest any limitation as to the scope of use or functionality of the invention. Nor should the computing environment 100 be interpreted as having any dependency or requirement relating to any one particular component or combination of components illustrated in the exemplary operating environment 100.

The invention may be described in the general context of computer-executable instructions, such as program modules, being executed by a computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system 100 for implementing the invention includes a series of computing devices 102 that are connected to a network, such as the Internet 104. While only two computing devices 102 are shown, it should be understood that in actual practice, there are countless devices 102 in use in implementing the present invention. Computing devices 102 are typically standard personal computers (PCs) of the type that are known by and familiar to almost everyone in our society. Devices 102 are equipped with browser software that allows the device 102 to access and display information obtained from the Internet to the person using the computer. Any number of different computing devices equipped with any number of software interfaces are within the scope of the present invention, so long as the computing device 102 can access the network 104 and display information to the user in some way.

The computing devices 102 access the network 104 and then in turn, access an agency 108 or an affiliate 106. The agency 108 and affiliate 106 are information providers to the users of the computing devices 102. The agency 108 is an on-line or Internet type travel agency. As such, the agency provides to the computing devices 102, and thus to users, information relevant to travel throughout the world. For example, agency 108 provides to the computing devices search screens which may be used to search for available service providers, such as hotels, flights or car reservations for a given city and a given date. Based upon the search criteria provided by the user, information regarding available service providers is returned to the user for selection, as is more-fully described below. As stated above, the computing devices 102 may also be used to access an affiliate 106. Affiliates 106 are other web-sites that contract with the agency 108 to offer the same or similar services as does agency 108. In effect, the agency provides all of the structure needed by the affiliate 106 and the affiliate 106 provides to the agency another venue through which to market its services. Thus, an affiliate is allowed to offer its customers and visitors the ability to research and purchase travel services (hotel, car, and air) when they visit the web-site of the affiliate. The agency 108 typically tracks all reservations made from the affiliate site and credits the affiliate a commission as soon as the service provider pays the agency 108.

The agency 108 obtains information regarding service availability and price through a global distribution system, or GDS, 110. A global distribution system is a computerized reservation network that provides subscribers with the ability to access schedule and fare information, book reservations and issue tickets. As an example, the global distribution system known as WORLDSPAN is suitable for use in the present invention. Moreover, while only one global distribution system 110 is shown in FIG. 1, it should be understood that multiple global distribution systems may be employed simultaneously in the present invention.

Each of a number of service providers 112 is connected to the global distribution system 110. The global distribution system may receive compensation from the agency 108, the service providers 112, or both. The compensation received by the global distribution system is independent of any transaction between the service provider and the agency 108. As a result, the GDS 110 has no interest in limiting the participating service providers. As one example implementation, the service provider 112 can be a hotel. The invention is in no way limited to hotels, but could be used for many other service providers as well. When a hotel room is booked through agency 108, the hotel 112 corresponding to the booking typically remits to the agency 108 a commission based upon the room rate and the number of nights the guest stays at the property. If the hotel room is booked through an affiliate 106 of the agency, the agency will compensate the affiliate after the hotel has paid the commission to the agency 108. As stated above, it is desirable for the agency 108 and the affiliate 106 to provide an incentive to the hotels to remit full and timely commission payments. The novel system for providing such an incentive is set-forth in more detail below.

System for Determining and Displaying Content

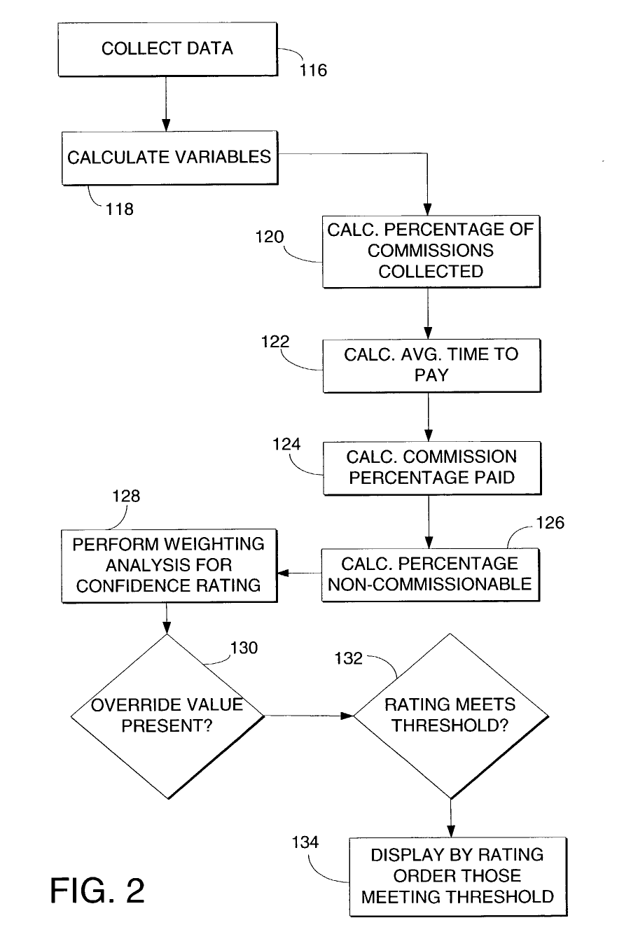

The system and method of the present invention, which involves the presentation of available travel services to the computing devices 102 based upon certain payment criteria of the service providers 112, will be explained below with reference to FIG. 2. While the exemplary formulas, variables and criteria presented are specifically designed for hotels, it should be understood by those skilled in the art that similar formulas, variables and criteria could be used for other travel services.

Turning then to FIG. 2, the method of the present invention begins with the agency 108 collecting and tracking certain data for each of the hotels 112 accessible through agency 108, as shown in step 116. The collected data is then used to calculate a number of payment variables, as is discussed more fully below. Preferably, the data collected includes, for each hotel 112, the number of confirmed bookings for the relevant time period (total CF). This is simply the number of bookings that were completed in the study period (described in further detail below) by a user through a computing device 102 for that particular hotel using agency 108 or an affiliate 106. Additionally, of the total confirmed number, the number of bookings for which the hotel 112 has paid a commission to the agency 108 is collected and tracked (collected CF). The number of confirmed bookings for which the hotel paid no commission is collected and tracked (non-comm. CF). The non-paid commission bookings are generally those for which the rate was either non-commissionable or for which the guest was reported as a “no-show.” Again, an example of a non-commissionable rate might be a military personnel rate or some type of special rate for which the hotel 112 has determined it will not pay a commission. The total amount received in commissions from the hotel 112 is also tracked (amount received). Similarly, the total real booking value for the hotel is also calculated and tracked (booking value). The total real booking value is simply the number of rooms booked multiplied by the number of nights reserved, multiplied by the nightly room rate for the room. Finally, the time, in days, that the hotel 112 took to pay the commission to the agency 108 is determined and collected (payment time). This is simply the date that the commission was received by the agency 108 minus the departure date of the guest associated with the particular booking, because a commission is not typically considered due and payable until after the departure date. After the above information has been collected, it is used to calculate a number of payment variables as shown generally as step 118 in FIG. 2.

While shown and described in a particular order, the variable calculations set-forth below can be done in any order. As shown at 120, the percentage of commissions collected is calculated. This calculation is performed as follows (collected CF*100)/(total CF). In words, the number of confirmed bookings for which commissions have been collected is multiplied by one-hundred and then is divided by the total number of confirmed bookings.

The average time to pay is calculated for each hotel 112, as shown at 122. This calculation is performed by summing the payment time for each collected booking and dividing that by the collected CF number. The formula is as follows: Σ(payment time)/collected CF. The result is the average time, in days, that the hotel 112 took to pay a commission.

The commission percentage paid is then calculated, as shown at 124. This calculation is performed as follows: ((Σ(amount received)*100)/(booking value)). In words, the amount received in sum of all amounts received in commissions from the hotel 112 is multiplied by 100 and is then divided by the total real booking value for all collected bookings. The result is the average percentage of the booking value that was paid to the agency 108 as a commission.

The final calculation, shown at 126, is a calculation to obtain the percentage of non-commissionable bookings reported. This calculation is performed by multiplying the number of confirmed bookings for which no commission was paid by one-hundred and dividing that number by the total number of confirmed bookings. The formula is as follows: ((non-comm. CF*100)/(total CF)). The result shows the percentage of the total bookings that the hotel 112 reported as being non-commissionable for some reason.

After the variables have been calculated as shown at 120 through 126, a weighting analysis is performed to obtain a “confidence rating,” as shown at 128. The weighting analysis is more fully described below. After the confidence rating is obtained, a determination is made as to whether an override confidence value is present within the system, as shown at 130. If an override value is present, that value is used rather than the confidence rating obtained at 128. As an example of where an override confidence value might be used, a hotel 112 may have a low confidence rating from step 128 because a large number of the commissions on their bookings have not yet been paid. Because this would result in their search results being ranked far below their competitors or to not be displayed at all, the hotel 112 can negotiate with the agency 108 to obtain an override confidence value for use in step 130 for a certain period of time with the understanding that they would soon be paying commissions on those bookings. This allows the hotel 112 a grace period in which to improve the calculated confidence rating 128.

The process continues at 132 with a determination as to whether each of the hotels 112 meet a predetermined threshold value. The confidence rating obtained at 128, or the override value 130, if present, is compared against this threshold value. If the confidence rating or override value is not above the threshold value, the hotel will not be returned to the computing device 102 as an option for booking. In a current preferred embodiment, the threshold confidence rating is 52. It should be understood that other threshold values are within the scope of the present invention. At 134, the process concludes by returning an ordered list to the computing device 102 that is responsive to a search query. The list is presented on the computing device 102 in an order according to the calculated confidence rating 128 or the override value 130. In this method, then, the hotels have an incentive to timely pay commissions to the agency 108, so that they are at or near the top of the list of options presented to users on the computing device 102. This calculation process is performed on a periodic basis, such as monthly.

As stated above, the process includes a weighting analysis 128 for the calculated variables to arrive at a confidence rating. The weighting set forth below is merely one example of the weighting that can be performed under the current method, and is not intended to be limiting in any sense. Other weighting values can be used and are within the scope of the present invention. Changes in weighting values may be utilized may be utilized to place additional emphasis on problematic areas. If the service providers are commonly paying a standard commission, it may be more beneficial to weight the collected percent and time to pay categories. In the example weighting analysis illustrated below, a certain number of points are assigned to each of the four variables discussed above. Again, these variables are: percentage of commissions collected; average time to pay; commission percentage paid; and percentage of non-commissionable bookings reported. In a preferred weighting example, the percentage of commissions collected and the commission percentage paid are each weighted at forty five percent of the available confidence rating total. The average time to pay and the percentage of non-commissionable bookings reported are each weighted at five percent of the available confidence rating total. Within each variable, a table of possible points granted is generated and specific point values are assigned for the variable when the calculated variable is between certain values. This process is described below with reference to the tables.

As shown in the table below, the percentage of bookings collected has a maximum available point value of forty five, which is assigned to those hotels whose percentage of bookings collected is equal to 100%. If the percentage of bookings collected is lower, say at 87%, the point value is found from the table to be 35.

| | |
|---|---|
| | BETWEEN |
| POINTS GIVEN | THESE VALUES |

| | | |
|---|---|---|
| 45 | 100 | 100 |
| 42 | 95 | 99 |
| 40 | 90 | 94 |
| 35 | 85 | 89 |
| 30 | 80 | 84 |
| 25 | 70 | 79 |
| 20 | 60 | 69 |
| 10 | 50 | 59 |
| 5 | 30 | 49 |

For the category of percentage of bookings collected, which is calculated in step 120, the percentage must be at least thirty percent in order to receive any points. The higher the percentage of bookings collected, the higher the point value that is given.

The average time to pay is weighted at five percent of the overall confidence rating. As shown in the table below, if the average time to pay calculated in step 122 is less than sixty days, the maximum point value of five points is given. If the average time to pay is above one-hundred and twenty days, no points are given. As previously defined, a commission becomes due and payable at the departure date, and the time to pay is calculated as the difference between the date received and the departure date. Payment prior to the guest's departure date (i.e. before or during their stay) would result in a negative amount.

| | |
|---|---|
| | BETWEEN |
| POINTS GIVEN | THESE VALUES |

| | | |
|---|---|---|
| 5 | −365 | 60 |
| 3 | 61 | 90 |
| 1 | 91 | 120 |

The next weighting analysis component is the commission percentage paid, which uses the value obtained in step 124. This weighting analysis uses the following table:

| | |
|---|---|
| | BETWEEN |
| POINTS GIVEN | THESE VALUES |

| | | |
|---|---|---|
| 45 | 10 | 100 |
| 40 | 9 | 9 |
| 35 | 8 | 8 |
| 30 | 7 | 7 |
| 25 | 6 | 6 |
| 20 | 5 | 5 |
| 15 | 4 | 4 |
| 10 | 3 | 3 |
| 5 | 2 | 2 |

As can be seen from the above-table, if the commission percentage paid calculated in step 124 is between ten percent and one-hundred percent, the maximum point value of 45 is given. As the commission percentage paid drops below ten, so do the points given for the confidence rating. Moreover, the commission percentage paid must be at least two percent in order to be awarded any points at all.

The percentage of reported non-commissionable bookings is also a part of the weighting analysis 128. The value calculated as described for step 126 is used in this weighting analysis. The following table is used in conjunction with that value:

| | |
|---|---|
| | BETWEEN |
| POINTS GIVEN | THESE VALUES |

| | | |
|---|---|---|
| 5 | 0 | 0 |
| 4 | 1 | 11 |
| 3 | 12 | 21 |
| 1 | 22 | 31 |

Therefore, if the hotel has no non-commissionable bookings, five points are given towards the overall confidence rating. Agency 108 is obviously desirous of having the lowest number of non-commissionable bookings as possible. The hotel is thus rewarded, through the confidence rating weighting analysis for either not listing non-commissionable rates, or paying a commission for all bookings.

At the conclusion of the rating analysis, the assigned points are summed to arrive at the overall confidence rating for the hotel 112. In order to have the highest confidence rating of 100, the hotel must pay for all bookings, such that the percentage collected is 100%, must pay within 60 days, must have no non-commissionable bookings and must pay a commission percentage of at least ten percent. As any of these variables drops, so does the confidence rating of the hotel. As the confidence rating of the hotel drops, the position of the hotel on the ordered list displayed to the user on computing device 102 will drop correspondingly. As stated above, it has been found that users are more apt to book with one of the hotels or other services at or near the top of the ordered list. The process and system described above therefore provide an incentive to the hotels to improve their payment performance. The weighting described above can be altered in any of a number of ways. For example, if the agency 108 believes that the average time to pay is an important variable, the weighting can be shifted from the five percent level to a higher weighted level, such as fifteen or thirty percent. Obviously, as the importance of one variable weighting is increased, the importance of the remaining variable weightings is corresponding decreased. The agency 108 may for business reasons change weighting over time, or apply different weightings to different product lines.

The calculations described above are conducted on a monthly basis, and are done to achieve a cumulative result. Preferably, the data is contained within a database program capable of performing the calculations and weighting analysis described above. The start date used for the calculations is a cut-off date based upon the earliest accurate booking records for the hotel. The start date may be changed, and old values zeroed out, if the hotel has had a change in management. Moreover, if any unpaid bookings are written off for accounting purposes on a periodic basis, all bookings for all service providers prior to the write-off period will no longer be used in the confidence rating calculation. The ending date used in the calculations is the latest booking departure minus sixty days. The sixty day time period is chosen as one which allows the hotel a reasonable amount of time to make payment. Currently, as new properties are added to the agency 108 web-site, the hotel will be assigned the minimum confidence rating needed to meet the minimum threshold. As the hotel continues, the confidence rating associated therewith can go up, provided the hotel makes timely payments of the anticipated commission percentage, etc., or down. The service providers 112, agency 108 and affiliates 106 are informed of the current confidence ratings for each of the service providers. If a particular affiliate desires, the affiliate can upwardly adjust the confidence rating cut-off or threshold needed to maintain a presence on their site.

The process provides incentives to service providers to improve their payment performance with respect to the agency 108. In this way, the agency 108 can demonstrate, in objective terms, the steps needed for the service provider to improve their confidence rating. The service provider is rewarded for a superior payment performance by obtaining a high confidence rating. The high confidence rating translates into a desirable position on the display of the computing device 102, such that a user is more likely to select that service provider for a booking. Again, while the example above details a hotel as the service provider, the invention applies to many other service providers equally.

The present invention has been described in relation to particular embodiments, which are intended in all respects to be illustrative rather than restrictive. Alternative embodiments will become apparent to those skilled in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated and within the scope of the claims.

What is claimed is:

1. A computer-implemented method for ordering service providers presented as options to computer users by an information provider, comprising:
obtaining, from a plurality of the service providers, data describing an attribute of the service provider relevant to the information provider;
determining, based upon the obtained attributes, an order in which to present the plurality of service providers; and
presenting, by the information provider, to the computer users the service providers in the determined order.

2. A computer-implemented method as recited in claim 1, wherein the obtained attributes are payment performance attributes of the service providers to the information provider.

3. A computer-implemented method as recited in claim 2, wherein the information provider is an Internet travel agency.

4. A computer-implemented method as recited in claim 2, wherein the service providers are hotels.

5. A computer-implemented method as recited in claim 4, wherein the obtained attributes are selected from the group consisting of the total number of confirmed hotel bookings, the number of confirmed bookings for which commissions have been received, the number of confirmed bookings for which no commission was paid, the amount received in commissions, the total real booking value and the time for payment.

6. A computer-implemented method as recited in claim 5, wherein said determining step further comprises:
calculating, using the obtained attributes, a plurality of payment variables from the hotel to the agency;
weighting the payment variables; and
summing the weighting variables to arrive at a rating for each hotel, wherein the rating for each hotel is used as the determinant in the presenting order.

7. A computer-implemented method as recited in claim 6, wherein said payment variables are selected from the group consisting of a percentage of commissions collected, an average time to pay, a commission percentage paid, and a percentage of reported non-commissionable bookings.

8. A computer-implemented method as recited in claim 6, further comprising presenting only those hotels with a rating above a predetermined threshold.

9. A computer-implemented method as recited in claim 3, wherein the obtained attributes are selected from the group consisting of the total number of confirmed hotel bookings, the number of confirmed bookings for which commissions have been received, the number of confirmed bookings for which no commission was paid, the amount received in commissions, the total real booking value and the time for payment.

10. A computer-implemented method as recited in claim 9, wherein said determining step further comprises:
calculating, using the obtained attributes, a plurality of payment variables from the hotel to the agency;
weighting the payment variables; and
summing the weighting variables to arrive at a rating for each hotel, wherein the rating for each hotel is used as the determinant in the presenting order.

11. A computer-implement method as recited in claim 10, wherein said payment variables are selected from the group consisting of a percentage of commissions collected, an average time to pay, a commission percentage paid, and a percentage of reported non-commissionable bookings.

12. A computer-implemented method as recited in claim 11, wherein the service providers are hotels.

13. A computer readable medium containing instructions for performing the method recited in claim 1.

14. A computer system having a processor, a memory and an operating environment, the computer system operable to execute the method as recited in claim 1.
